(19) United States
(12) Patent Application Publication
(10) Pub. No.: US 2011/0064531 A1
(43) Pub. Date: Mar. 17, 2011

(54) CUTTING APPARATUS AND METHOD

(76) Inventor: Howard George Osborne, Isle of Man (GB)

(21) Appl. No.: 12/517,209

(22) PCT Filed: Dec. 5, 2007
(86) PCT No.: PCT/US07/50742

§ 371 Date: Dec. 6, 2010

(30) Foreign Application Priority Data
Dec. 6, 2006 (GB) 0624385.1

(51) Int. Cl. B27F 5/12; B23B 47/28

(52) U.S. Cl. 408/103; 408/115 R

(57) ABSTRACT

An apparatus for use in cutting a mortice pocket in a leading edge of a door in-situ, the apparatus comprising: at least one elongate guide means; clamping means for clamping the elongate guide means to a door or other workpiece; a drill guide means mounted on the elongate guide means; and translating means; wherein the drill guide means comprises a bearing block and a saddle member, the saddle member having a bearing block aperture formed therethrough arranged to releasably receive the bearing block therein, the bearing block having a hole therethrough adapted snugly to receive a drill shaft such that the drill shaft is supported, directly or indirectly, by the bearings of the bearing block and is rotatable therein, and wherein at least one of the bearing block aperture and the bearing block is tapered.

The present invention relates to apparatus for use in cutting a workpiece. In particular, but not exclusively, the invention relates to apparatus for cutting a mortice pocket, hinge recess or latch plate recess in a vertical edge of a door. The invention further relates to apparatus for cutting an aperture such as a cylindrical cylinder lock aperture or circular handle shaft aperture in a face of a door. It also relates to apparatus for cutting a letter box opening in the face of a door.

The cutting of a mortice pocket or a front plate recess in an edge of a door, or the cutting of a hinge rebate, or of a cylindrical aperture in a face of a door, are known to be challenging tasks even to a skilled worker. The problem is particularly acute if cutting takes place in-situ, such as when installing a lock in a door that has already been hung. Mistakes in chiselling or machining may require the entire door to be discarded and replaced.

GB2238749 discloses a jig, for use in cutting a mortice lock aperture into a workpiece such as a door, having a pair of cheek plates 12, 14 and a clamping plate 64 by means of which the jig may be clamped to the workpiece. A drill bit guide 28, 30 is mounted on guide rods 16, 18 connecting the cheek plates. A mortice is cut by sequentially drilling holes using a series of apertures in the drill bit guide 30 to guide the drill bit. The invention suffers the disadvantage that material remaining between the drilled holes must be cut away using a chisel before a mortice lock can be fitted.

WO 88/10177 discloses a guide for cutting a mortise comprising a drill guide part 2 having a drill guide aperture 21 passing therethrough, the aperture 21 comprising a plurality of overlapping cylindrical shapes 20. A mortice may be cut by using the guide to drill a sequence of holes. The guide suffers the disadvantage that arcuately pointed parts are left around the edge of the aperture as drilled, which must subsequently be removed using a chisel.

According to a first aspect of the invention there is provided apparatus for use in cutting a mortice pocket in a leading edge of a door in-situ, the apparatus comprising:
at least one elongate guide means;
clamping means for clamping the elongate guide means to a door or other workpiece such that the elongate guide means is substantially parallel to a leading edge thereof;
a drill guide means mounted on the elongate guide means so as to be reciprocally moveable therealong; and
translating means to translate the drill guide means in a direction having a resolved component normal to the elongate guide means;
wherein the drill guide means comprises a bearing block and a saddle member, the saddle member having a bearing block aperture formed therethrough arranged to releasably receive the bearing block therein, the bearing block having a hole therethrough adapted snugly to receive a drill shaft such that the drill shaft is supported, directly or indirectly, by the bearings of the bearing block and is rotatable therein, and wherein at least one of the bearing block aperture and the bearing block is tapered.

The apparatus enables both mortice pockets and hinge rebates to be cut in a door quickly and efficiently.

Such apparatus has the advantage that the bearing block may be conveniently attached to and removed from the apparatus in a rapid and efficient manner. There is no requirement to use standard or bespoke tools in order to remove the bearing block. Furthermore, a bearing block attached to the apparatus may be readily exchanged for a different bearing block. More importantly, perhaps, with a tapered connection radial play between the bearing block and saddle member can be eliminated.

Preferably, both the bearing block aperture and the bearing block are tapered. The taper angle of the bearing block may be in the range from about 1° to about 10°, preferably from about 3° to about 5°.

Preferably, a relative angle is arranged between an outer surface of the bearing block receivable within the bearing block aperture, and an inner surface of the bearing block aperture, and this angle is in the range from about 0.1° to about 5°. That is to say, preferably, there is a difference between the taper angle of the bearing block and the bearing block aperture, with the bearing block aperture having the greater tape angle.

Preferably, the relative angle is in the range from about 0.1° to about 0.5°, more preferably from about 0.2° to about 0.3°.

The advantage of this arrangement is that, with equal tapers it is possible for the bearing block to jam in the bearing block aperture. With different tapers the connection between the bearing block and the saddle member is around a circular line so that friction is reduced and the parts are more easily separated. Provided, however, that the taper angle difference is quite small, the capacity for angular misalignment between the two components is minimal.

Indeed, preferably, the diameter of the bearing block is approximately the same as its length, or at least not more than 15% different in dimension.

A keyway has been found to be advantageous in that it assists insertion and removal of the bearing block into and from the saddle member.

Preferably, the keyway comprises an axial portion. More preferably, the keyway also comprises a helical portion.

The presence of an axial portion (ie a portion running substantially parallel to a long axis of the bearing block) and a helical portion has the advantage that the axial portion is useful in guiding initial insertion of the bearing block into the bearing block aperture, without the need to twist the bearing block, whilst the helical portion assist a user in obtaining a tight fit of the bearing block in the bearing block aperture.

The resultant ‘key and twist’ action of the bearing block in combination with the relative taper between the block and the aperture provides a particularly convenient and stable connection.

This helps to prevent the bearing block and any drill shaft held by the bearing block from accidentally disengaging from the drill guide means. The apparatus may further comprise a drill shaft received in the drill guide means, the drill shaft being provided with a drill bit.

The direction of the apparatus having a resolved component normal to the elongate guide means may itself be substantially normal to the elongate guide means (this is generally preferred), or may be disposed at an angle of less than 90° thereto.

The means for translating the drill guide means may be arranged to translate both the elongate guide means and the drill guide means together, or may be arranged to translate the drill guide means independently of the elongate guide means.

The apparatus has the advantage that different thicknesses of mortice may be cut by translating the drill guide means between predetermined limits. Moreover, the apparatus may be used to cut rebates (e.g. for face-plates or hinges) on sides parts of the door or workpiece, or even hinge rebates on parts of a door frame.

Preferably, first and second adjustable stopping means are provided on the elongate guide means so as to define limits of travel of the drill guide means along the elongate guide means.

A rack and pinion or worm screw or similar mechanism may be provided for moving the drill guide means along the elongate guide means. This type of mechanism may also be used for effecting translation of the drill guide from side to side. This has the advantage that smooth, controlled movement of the drill guide means along the elongate guide means may be effected.

At least first and second elongate guide means may be provided. The first elongate guide means may include a rack of said rack and pinion mechanism. The stopping means may be mounted on the second elongate guide means.

A pinion of said rack and pinion mechanism may be located in the drill guide means.

The clamping means may be configured such that the elongate guide means may be moved in a direction substantially perpendicular to their extent. In addition, the clamping means may be configured to allow controlled lateral movement of the drill guide means, in addition to reciprocal movement along the elongate guide means.

Alternatively, the drill guide means may include a cylindrical aperture configured rotatably to receive a bobbin. The bobbin may be provided with a through hole adapted to receive a drill shaft. At least one of the bobbin or cylindrical aperture may be tapered.

The bobbin may be made of or coated with a low-friction material, or be provided with a collar made of a low-friction material. Alternatively or in addition the bobbin may be made of an elastomeric material.

The drill shaft may be adapted for connection to a power drill. Alternatively, the apparatus may further comprise an integral motor for rotating the drill shaft.

Advantageously the drill bit is adapted to produce small swarf. This permits a mortice pocket to be cut without the need to withdraw the rotary cutting means at intervals during cutting of a mortice pocket, since the small swarf is readily ejected from the mortice pocket during rotation of the cutting means.

Preferably, the drill bit comprises a shaft, the shaft having a major axis along a length of the shaft about which the drill bit is rotated in normal operation, the shaft having a leading end and a trailing end, the trailing end being adapted to be gripped in the chuck of a drill, wherein the leading end of the shaft is provided with a plurality of blades disposed radially with respect to the major axis of the shaft, the blades having a leading edge and a leading surface, wherein the leading edge is shaped to provide a cutting edge, and the leading surface is disposed on the side of the blade that faces a direction of rotation of the drill bit.

The leading end of the shaft may be provided with a spike, the spike lying along the major axis and protruding away from the drill bit, each blade further comprising a longitudinal edge distal the major axis, the longitudinal edge describing a substantially helical form, coaxial with said major axis. The blades may be provided with a plurality of teeth along said longitudinal edge. The teeth enable the drill bit to cut along a radial direction when the bit is translated in a radial direction.

Alternatively, the leading surface may be generally planar and the blades disposed such that an angle between the plane of the surface of the workpiece to be cut and the plane of the leading surface is greater than substantially 90°.

Preferably the drill bit has four blades.

Preferably the clamping means comprises at least one clamp, the at least one clamp being operable to grip opposite faces of a door.

The clamping means may be further operable to grip a clamp adaptor, the clamp adaptor comprising means for attachment to the leading edge of a door.

The clamp adaptor may be configured to grip opposite faces of a door, wherein, with the apparatus clamped to the clamp adaptor, the apparatus is mountable with the drill guide means in juxtaposition with a face of the door.

This feature has the advantage that the apparatus may be mounted to a face of the door thereby to allow an aperture to be cut through the thickness of the door.

An aperture of oval cross-section corresponding to that of a cylinder lock may be made by reciprocal movement of the drill guide means parallel to a leading edge of the door.

The clamp adaptor may be provided with at least one hook means, the at least one hook means being configured to hook around a portion of the apparatus thereby to restrain movement of the guide means relative to the adaptor.

The apparatus may further comprise a clamp adaptor comprising a clamp block, the clamp block having a spindle connected thereto.

Preferably the spindle comprises a threaded rod.

Preferably the drill guide means comprises index means arranged to cooperate with the elongate guide means to index a position of the drill guide means with respect thereto.

Preferably the clamping means comprises a pair of opposed jaws.

The clamping means may be arranged to open or close the jaws in a symmetrical manner thereby to allow a portion of the clamping means to remain substantially midway between the jaws.

Preferably the apparatus comprises a detent mechanism arranged to allow the drill guide means to be located at a position midway between the jaws.

In a second aspect of the invention there is provided a method of forming a mortice pocket comprising the steps of:
providing a mortice cutting apparatus according to the first aspect; and
cutting a hole in a workpiece using the apparatus.

Preferably the method further comprises the steps of:
cutting a hole to a first depth; and
moving the drill guide means along the elongate guide means thereby to cut an elongate slot in the workpiece.

In a third aspect of the invention there is provided a method of forming a letter box aperture in the face of a door, comprising the steps of
providing a mortice cutting apparatus according to the first aspect;
drilling holes through the door to provide fixing apertures for a letter box plate
clamping the apparatus to a face of a door by inserting clamp blocks through the fixing apertures and fixing them to the face of the door whereby the apparatus may itself be clamped to the door;
cutting a letter box aperture in the face of the door using the apparatus.

For a better understanding of the present invention and to show how it may be carried into effect, reference shall now be made by way of example to the accompanying drawings, in which:

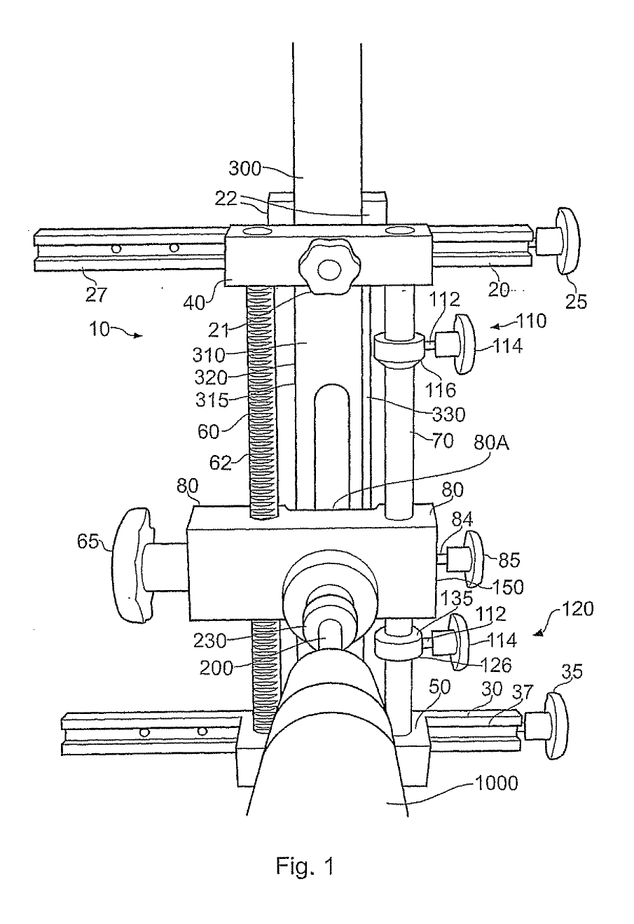

FIG. 1 is a perspective view of a mortice cutter of a first embodiment of the invention mounted to a door;

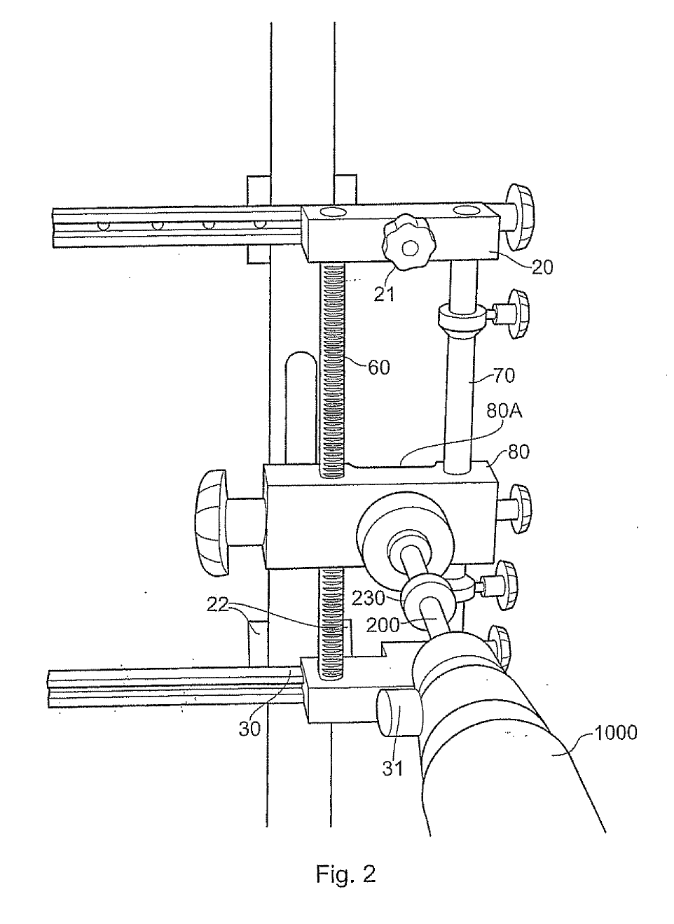

FIG. 2 is a perspective view of a mortice cutter of the first embodiment of the invention with the carrier positioned at an extreme end of the lateral slide means;

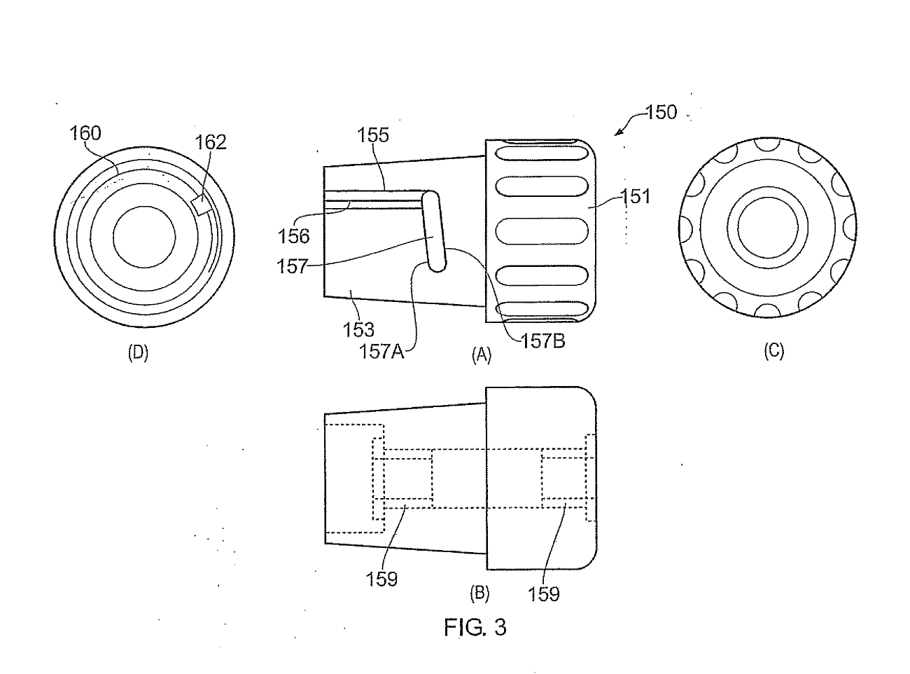

FIG. 3 shows (a) a side elevation of a bearing block; (b) a side elevation with internal detail of a bearing block; (c) a front elevation of a bearing block; and (c) an aperture of a carrier of apparatus according to the first embodiment;

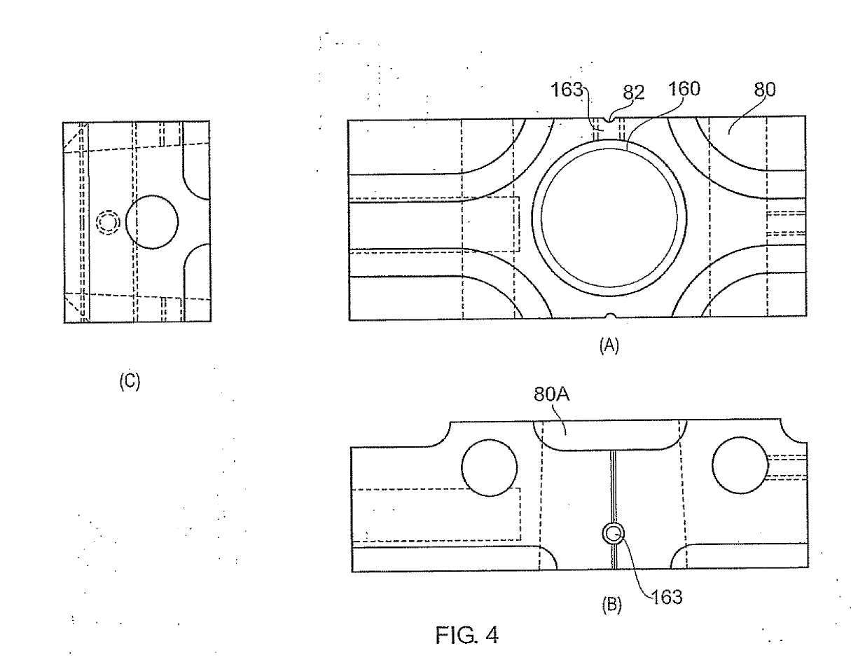

FIG. 4 shows (a) a front elevation of a carriage; (b) a plan view of a carrier; and (c) a side elevation of a carrier of apparatus according to the first embodiment;

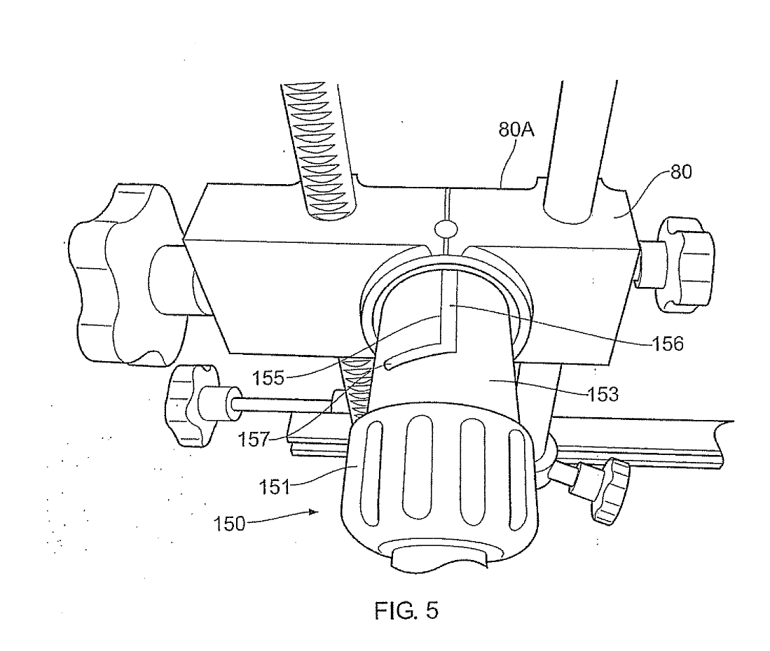

FIG. 5 is a perspective view of a bearing block being mounted to a carrier of apparatus according to the first embodiment;;

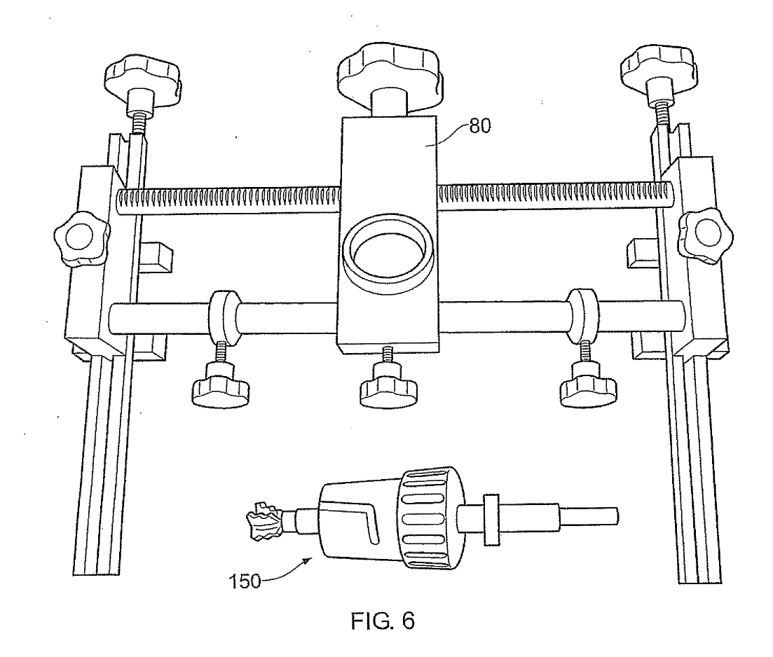

FIG. 6 is a perspective view of components of apparatus according to the first embodiment;

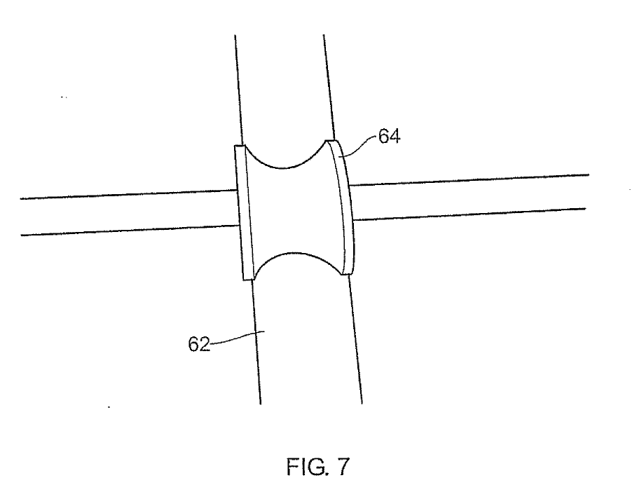

FIG. 7 shows a rubber wheel and bar of apparatus according to a variation of the first embodiment;

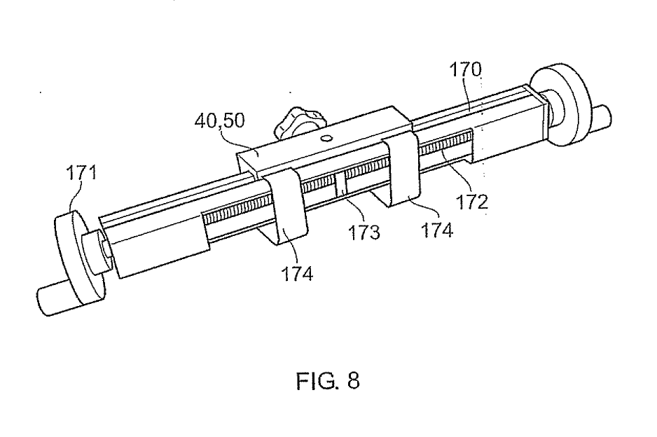

FIG. 8 shows a self-centering clamp unit of apparatus according to a variation of the first embodiment;

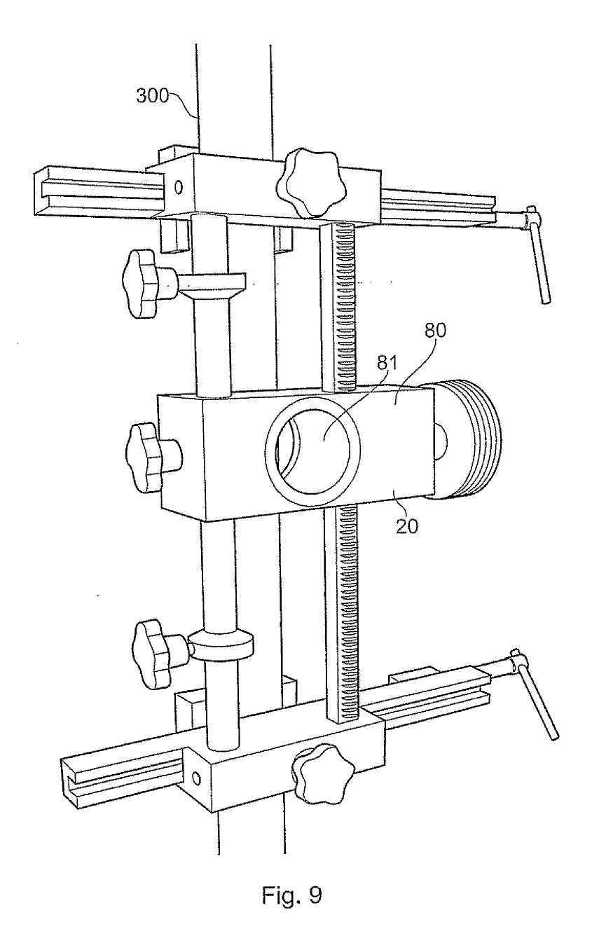

FIG. 9 is a perspective view of a mortice cutter of a second embodiment of the invention;

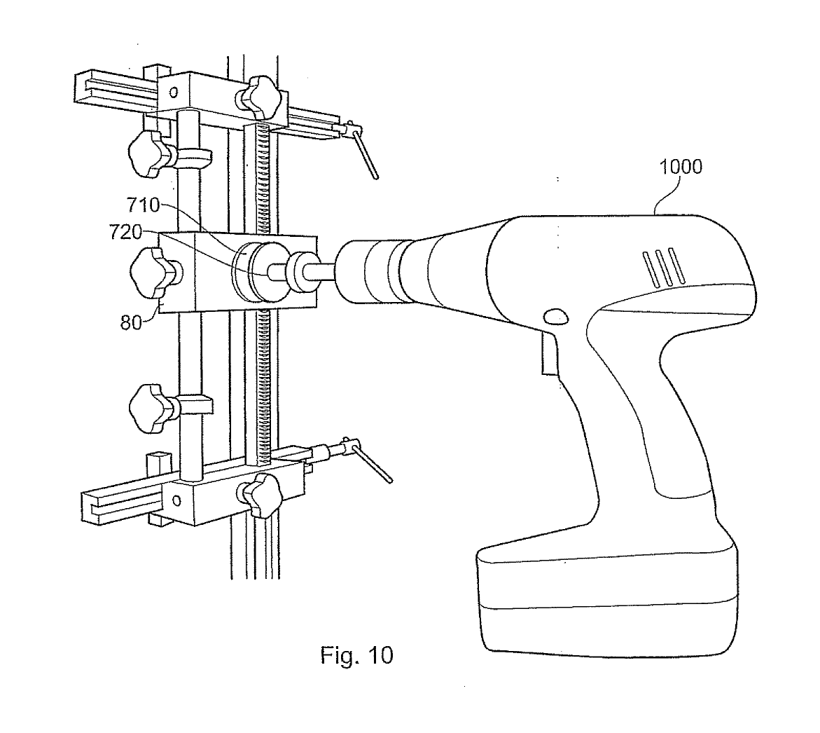

FIG. 10 is a perspective view of a mortice cutter of the second embodiment of the invention with a bobbin, drill bit and hand drill mounted to the carrier;

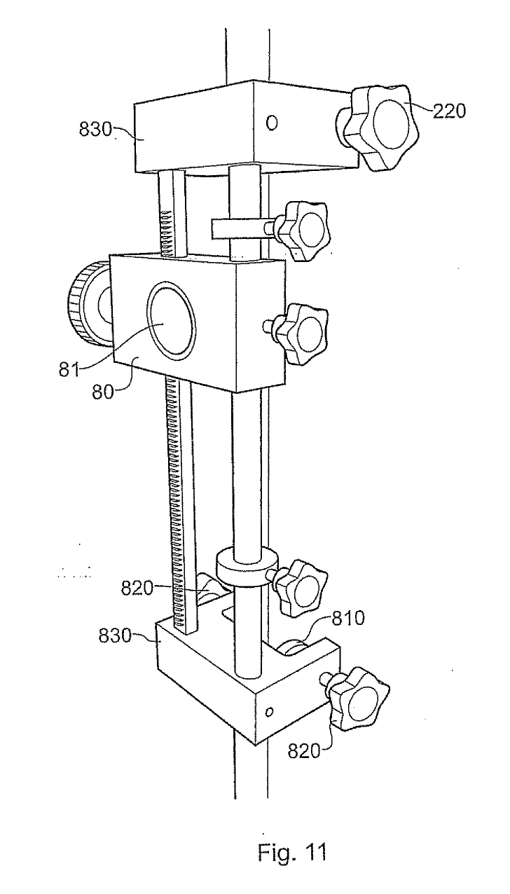

FIG. 11 is a perspective view of a mortice cutter of a third embodiment of the invention;

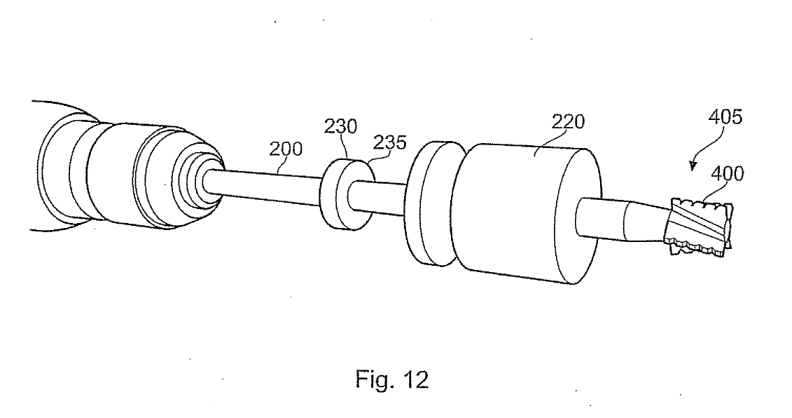

FIG. 12 is a view of a first embodiment of a drill bit for use with the mortice cutter with a bobbin mounted thereon;

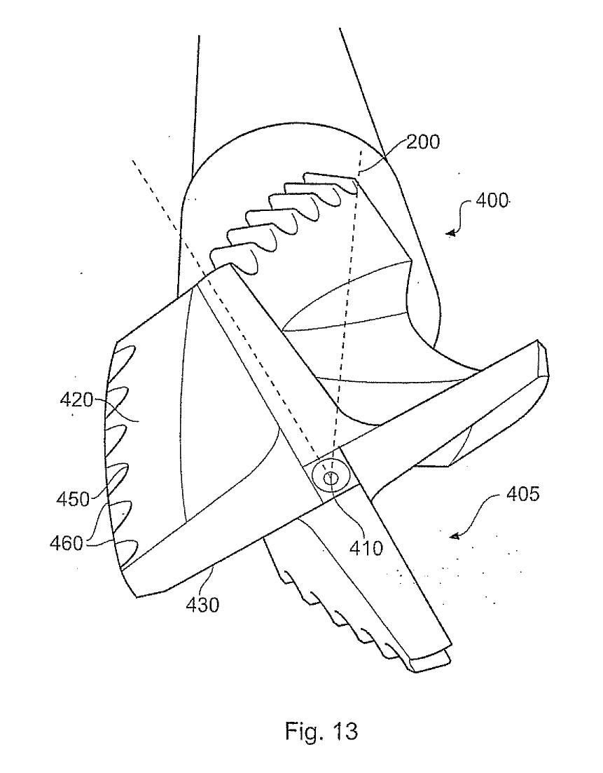

FIG. 13 is an axial view of the first embodiment of a drill bit for use with the mortice cutter;

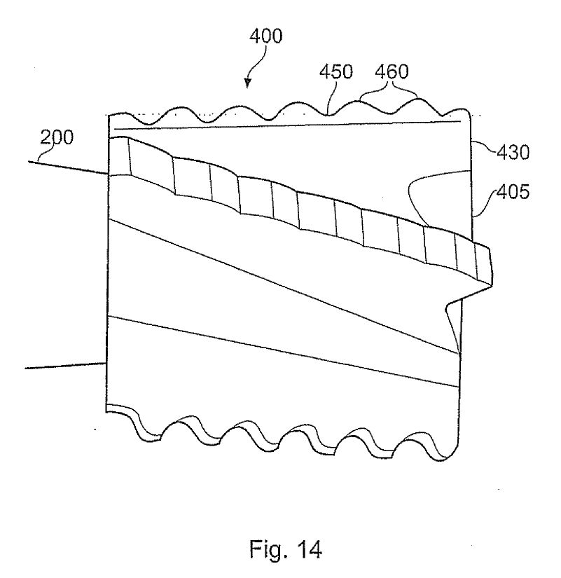

FIG. 14 is a side view of a first embodiment of a drill bit for use with the mortice cutter;

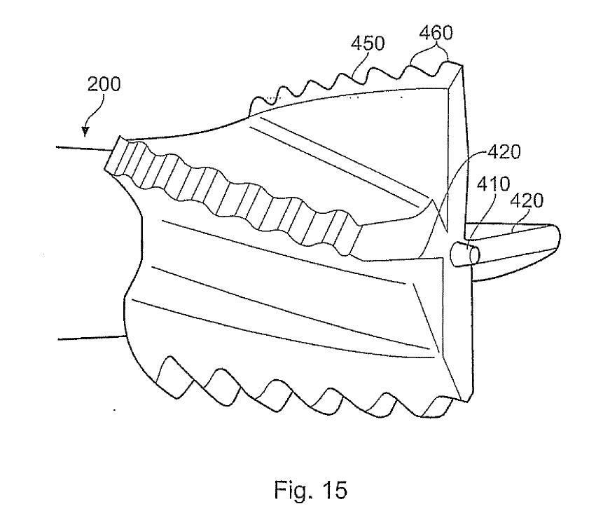

FIG. 15 is a perspective view of a first embodiment of a drill bit for use with the mortice cutter;

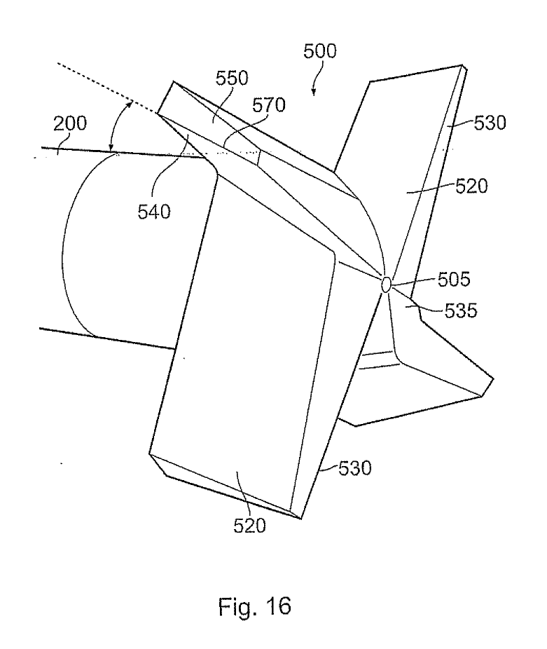

FIG. 16 is a perspective view of a second embodiment of drill bit for use with the mortice cutter;

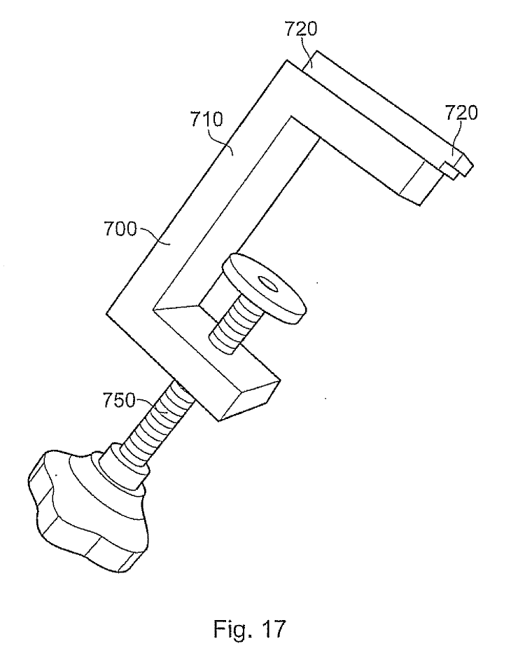

FIG. 17 is a perspective view of a clamp adaptor;

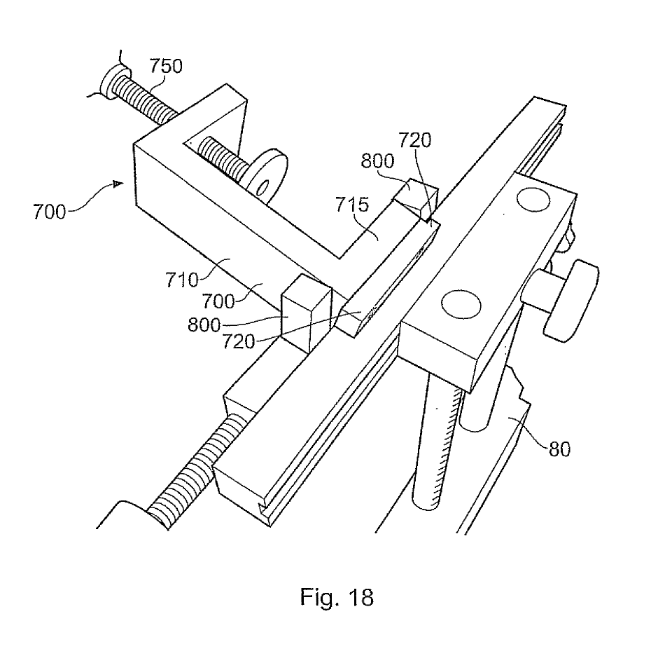

FIG. 18 is a perspective view of a clamp adaptor being installed between clamp members of a mortice cutter of a first embodiment of the invention;

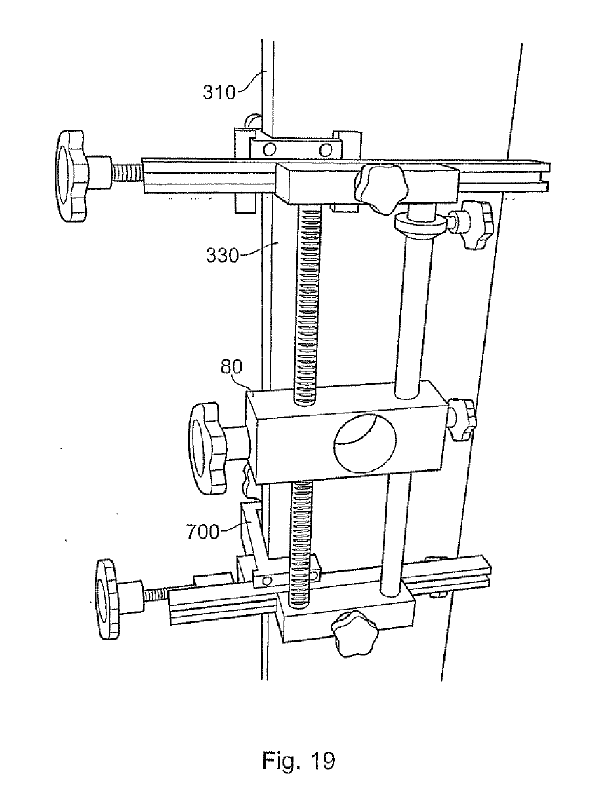

FIG. 19 shows a mortice cutter of the first embodiment of the invention mounted to a face of a door;

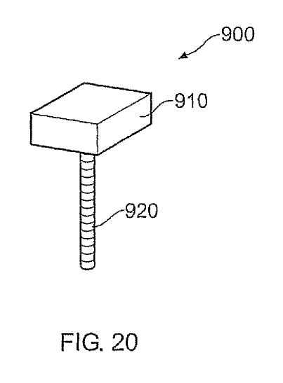

FIG. 20 shows a further clamp adaptor of the first embodiment of the invention;

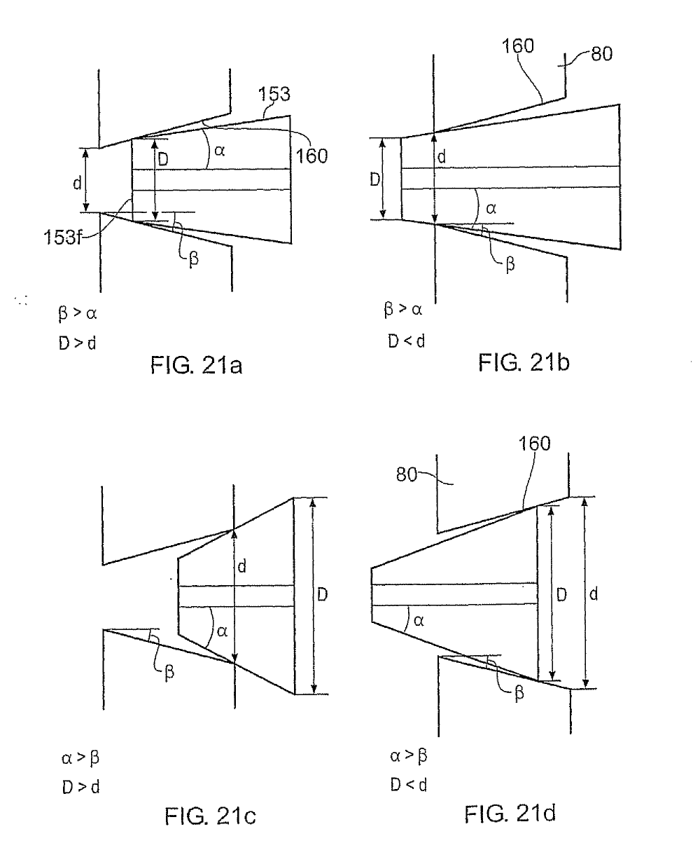

FIG. 21 shows alternative configurations of relative taper angles and diameters of a bearing block and bearing block aperture; and

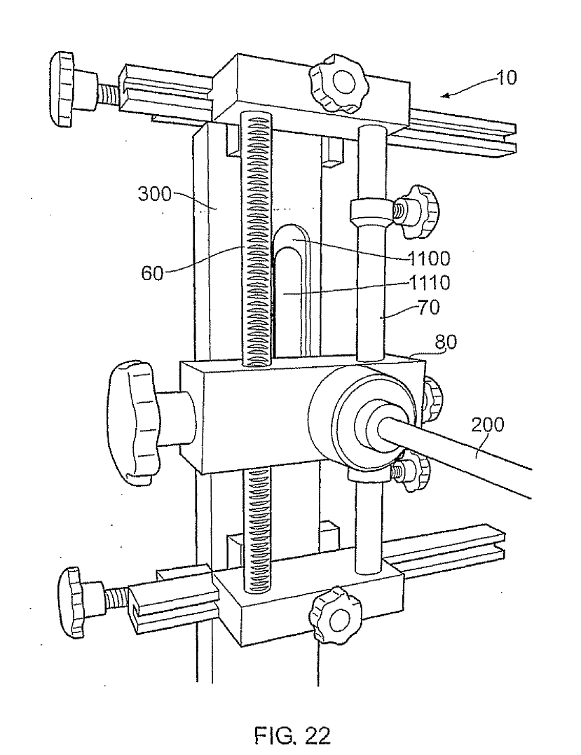

FIG. 22 shows a further perspective view of apparatus according to the second embodiment showing a lock plate recess and a mortice recess.

In a first embodiment of the invention, an apparatus 10 comprises an upper transverse slide 20 and a lower transverse slide 30, each slide 20, 30 comprising a pair of clamp jaws 22 having rotary handles 25. Yokes or carriages 40, 50 slide within tracks 27, 37 of each slide 20, 30. The carriages 40, 50 are connected to opposite ends of a toothed bar or rack stanchion 60 and a parallel slide bar or plain stanchion 70 such that the toothed bar 60 and slide bar 70 are perpendicular to the slides 20, 30. The clamps 22 allow the apparatus to be mounted in juxtaposition with a leading surface 310 of a door 300, the leading surface 310 being the surface between a front side 320 (FIG. 1) and a back side 330 (FIG. 2) of the door. The apparatus is oriented such that the toothed bar 60 and slide bar 70 are parallel to the surface 310.

The toothed bar 60 and slide bar 70 each pass through cylindrical passages of a carrier or saddle 80, such that the carrier 80 may slide along the toothed bar 40 and slide bar 50. The carrier 80 is machined from a block of aluminium.

The carrier 80 has a bearing block 150 mountable in a bearing block aperture 160 of the carrier 80. The bearing block 150 has an axial hole therethrough, through which a drill bit 200 may be passed. According to the first embodiment the hole is lined by a pair of low friction bushes 159 which grip an inner surface of the block 150. In variations of the first embodiment the bushes are glued within the hole. A drill bit inserted through the hole is slidably rotatable with respect to the bush.

The bearing block 150 is oriented such that in use the axis of rotation of the drill bit 200 is substantially normal to the slide bar 70 and transverse slides 20, 30. The bearing block is located between the toothed bar 60 and slide bar 70.

The bushes are made from a self-lubricating material such as a sintered porous metallic material (eg Oilite™ bearing). In some embodiments the bushes are made from a low friction plastics material such as PTFE, or any other suitable bush material. In alternative embodiments a single bush may be used.

In further variations of the first embodiment, the hole may be lined by the outer sleeve of a rotatable bearing unit, the rotatable bearing unit have an inner sleeve, the inner and outer sleeves having movable bearings therebetween such as ball bearings. In use, the inner sleeve engages a drill bit 200 and rotates with the drill bit 200. The outer sleeve is fixed with respect to the bearing block 150 and does not rotate with respect thereto.

To accommodate different sized drill bits 200, bearing blocks having different diameter holes therethrough may be provided. Alternatively, different sized bushes may be provided, the bushes or bearing units being releasably insertable into the bearing block. As a further alternative, sleeves may be provided, insertable into the hole, to accommodate variations in drill bit diameter.

The bearing block 150 (FIG. 3) has a handle portion 151 at a first end, the handle portion having serrations to assist a user in gripping and rotating the handle portion. At a second end opposite the first end the block 150 has a tapered portion 153. The tapered portion tapers at an angle of about 3°, being narrower at the second end than the end proximate the handle portion 151.

A keyway 155 is formed in the tapered portion 153. The keyway has a portion 156 running substantially axially along the block 150, and a helical portion 157. The helical portion 157 is at an angle of about 5° to a radial direction of the block 150.

The bearing block aperture 160 has a taper corresponding to that of the tapered portion 153 of the bearing block 150. However, the taper angle is slightly shallower than that of the bearing block 150 in order to prevent binding of the bearing block 150 in the aperture 160. Thus, a difference in taper angles of about 0.25° is provided. In other words, the bearing block aperture 160 tapers at an angle of about 2.75° instead of 3°. There is therefore a divergence angle of about 0.25° between the components.

Resilience of the plastics material from which the bearing block 150 is made enables the tapered portion to flex within the aperture 160 in order to form a snug fit when the bearing block 150 is installed.

In FIG. 21, four possible arrangements of the bearing block taper 153 and bearing block aperture taper 160 are shown. In FIGS. 21a and b, the taper angle β of the bearing block aperture is greater than the taper angle α of the bearing block. However, the diameters are arranged differently between the two figures, where in FIG. 21a, the diameter D of the front end 153F of the tapered portion of the bearing block 153 is greater than the minimum diameter d of the bearing block aperture 160. The converse is the case in FIG. 21b, and the effect is that in the first case, the front edge of the bearing block wedges into the aperture 160, whereas in the latter case, the rear edge of the aperture bites into the side of the block.

FIGS. 21c and d show the opposite arrangement in which the taper angle α of the bearing block is larger than the taper angle β of the bearing block aperture 160. D and d are as above, except here refer to the front edge of the bearing block aperture and trailing end of the tapered portion of the bearing block 153.

All four arrangements are approximately equivalent. However, the arrangement described above with reference to FIGS. 3 and 4 corresponds with the arrangement of FIG. 21c.

It will be appreciated that in the first embodiment of the invention the relative angle of taper and resilience of the bearing block have been selected such as to result in a snug fit between the tapered portion of the bearing block 153 and the inner wall of the bearing block aperture 160. In other words, forces on the bearing block 150 are transferred to the carrier 80 over substantially the whole of the area of the tapered portion of the bearing block that protrudes into the bearing block aperture 160. This assists in at least substantially eliminating chatter between bearing block 150 and carrier 80 during cutting operations.

A key 162 is provided in a sidewall of the bearing block aperture 160. The key is in the form of a grub screw plug that screws into a threaded bore 163 (FIG. 4) of the carrier 80.

In use, the bearing block 150 is inserted into the bearing block aperture 160 and the key 162 located in the keyway 155 (FIG. 5). The key 162 runs along the keyway 160 as the block 150 is inserted further into the aperture 160. When the key 162 arrives at the helical portion 157, the block 150 is rotated to pass the key along the helical portion. At this stage, the key 162 will exert a pressure on an innermost sidewall 157A of the helical portion 157 of keyway 155. The outer surface of the tapered portion 153 of the bearing block 150 is thereby eased into wobble-free engagement with an inner surface of aperture 160. The presence of a difference in taper between the aperture and block 150 allows a degree of flexing of the block 150 to achieve releasable wobble-free engagement.

When it is required to remove the bearing block 150, the block 150 is rotated in an opposite direction to the direction of tightening (in the embodiment shown, released by rotating in an anticlockwise direction). Key 162 is then forced against outermost sidewall 157B of the helical portion 157 of keyway 155. Thus, the block 150 is eased out of the aperture 160 and may be conveniently withdrawn.

The fact that both the bearing block 150 and bearing block aperture 160 are tapered is important in enabling an effective interference fit of the block 150 into the aperture 160. The ‘cam lock’ action of the helical portion of the keyway conveniently provides the necessary pressure to achieve the desired fit.

If the bearing block aperture 160 is not tapered, it is found that wobble of the bearing block 150 is worse than in the case of a tapered bearing block aperture undesirable. Chatter of the bearing block results when the device is in use.

A notch 82 is formed in an upper surface of the carrier 80, at a location directly above an axis of rotation of the bearing block 150. The notch 80 assists in aligning the carrier 80 with the centreline of a door; thus, carriages 40, 50 may be moved to align the notch 82 with (say) a scribe line or other marking on the door 300.

Furthermore, the carrier 80 is shaped to assist a user in viewing the location of contact between a drill bit 200 and the door 300, at which position cutting of the door will occur. Thus, in the first embodiment, a body of the carrier 80 has a bevelled recess portion 80A. The carrier 80 may be further shaped to reduce an amount of material used in fabricating carriers 80 by a casting technique, in order to reduce manufacturing costs.

A rotary handle 65 projects from a side of the carrier 80 and is connected, within the carrier, to a toothed wheel (not shown) which engages teeth 62 of the toothed bar 60. Rotation of the handle 65 results in translation of the carrier 80 along the toothed bar 60 and slide bar 70.

In variations of the first embodiment, the teeth corresponding to those of the toothed bar 60 are provided on at least a portion of the bearing block 150. Apparatus according to such embodiments is configured such that the teeth of the bearing block 150 engage those of the toothed bar 60, such that rotation of the bearing block 150 causes movement of the carrier 80 along the toothed bar 60 and slide bar 70.

In a still further variation of the first embodiment, a toothed slide bar 60 is not used. Instead a plain slide bar 62 (FIG. 7) is employed. A rubber wheel 64 having a convex dimple formed in the circumference of the wheel is provided in the carrier in place of a toothed wheel, the wheel 64 being arranged to engage the plain slide bar 62. In some embodiments the slide bar 62 has a roughened surface in order to promote grip between the rubber wheel 63and the slide bar 62. It will be appreciated that the wheel may be made from any suitable material to promote grip between the wheel and the slide bar 62.

The use of a rubber wheel has the advantage of eliminating the requirement for toothed bar stock, which is relatively costly. Furthermore, a requirement for a corresponding toothed wheel mechanism within the carrier 80 is also eliminated.

In some embodiments a corresponding rubber strip is provided on plain slide bar 62. The rubber strip may be recessed into the bar 62. The strip assists in promoting grip between the wheel 64 and the bar 62.

The carrier 80 is fitted with a friction adjustment mechanism which comprises a screw 84 fixedly connected to a rotary handle 85. The screw 84 may be screwed into the carrier 80 so as to abut the slide bar 70. A frictional force may thereby be applied between the carrier 60 and the slide bar 70. In some embodiments of the invention such a friction adjustment mechanism is not required.

An upper stop 110 and a lower stop 120 comprise annular rings 116, 126 through which the slide bar 70 passes, and are positioned at locations of the slide bar 70 either side of the carrier 80. The stops 110, 120 may be moved along the slide bar 50 so as to bracket the length of the slide bar 70 along which travel of the carrier 80 is required. The stops 110, 120 each have a screw 112, each having a rotary handle 114 that may be used to tighten the screws against the slide bar 70 so as to lock the position of the stops 110, 120.

The lateral position of the carrier 80 may be varied by sliding along the transverse slides 20, 30. When a cutting operation is being performed, the carriages 40, 50 may be locked in position using the upper and lower friction grips 21, 31, respectively.

When cutting a mortice pocket, the carrier will typically be positioned midway between opposite faces 320, 330 of the door 300. When cutting a hinge rebate, the carrier will typically be positioned such that the recess is made towards an edge of the trailing surface (not shown) of the door 300.

In a variation of the first embodiment, a self-centering clamp mechanism 170 (FIG. 8) is employed. The self-centering clamp mechanism 170 replaces the clamps 22 and rotary handle 25. Mechanism 170 has clamp knobs 171 connected to opposite ends of a threaded rod 172. Threaded rod 172 has a right-handed thread along one half of the rod, and a left-handed thread along another half of the rod. A brass bush 173 is located midway along the rod, and separates the left and right-hand threaded portions. A clamp block 174 is provided on each side of the bush 173, the blocks 174 each having a threaded bore through which the rod 172 passes. The mechanism is configured such that rotation of a knob 171 in one direction results in translation of the blacks 174 away from one another, whilst rotation in the opposite direction results in translation of the blocks 174 towards one another. The motion is symmetrical about the bush 173.

Thus, the bush 173 is always at the midpoint of the two clamps. When the mechanism is clamped to a door 300, with the door gripped between the clamps 173, the bush will be midway between opposed side faces of the door 300.

A detent is provided in the middle of at least one of the carriages 40, 50, to provide a positive latching action with respective slides 20, 30 of the apparatus. It will be appreciated that the midpoint of slides 20, 30, which are integral to respective self-centering clamp mechanisms of the apparatus, will always be at the centre of a workpiece (such as a door) gripped between clamp jaws of apparatus having a self-centering clamp mechanism 170.

The detent mechanism may comprise a ball and spring mechanism of one component operable to index a corresponding recess in the other component. Alternatively a latch mechanism such as a sprung piston attached to one component may be employed, the piston engaging a corresponding recess in the other component.

Apparatus according to the first embodiment further has an indexed mechanism allowing the carrier 80 to be fixed at predetermined positions along slide bars 60, 70.

In the first embodiment, the mechanism has a sprung ball device mounted to the carrier 80, which engages corresponding dimples in toothed bar 60. In some embodiments the dimples are provided in the slide bar 70; in some embodiments dimples are provided in both the toothed bar 60 and the slide bar 70. It will be appreciated that the indexed mechanism is compatible with other embodiments of the invention herein described.

The dimples are spaced along the length of toothed bar 60 and allow the carrier 80 to be moved along the bars 60, 70 and returned to precisely the same location at a later time.

This feature is particularly advantageous when cutting dowel holes in corresponding pieces or material to be joined. The indexing mechanism enables the positions of the dowel holes in respective pieces to be accurately aligned.

Slide bar 70 is provided with a scale to enable the position of the carrier 80 along the bar 70 to be determined, and the carrier reliably moved between known positions.

In some embodiments of the invention, teeth of the toothed bar 60 provide the required dimples for the detent mechanism.

In a further variation of the first embodiment, at least one of carriages 40, 50 may be removed from the apparatus and mounted at a location on the same side of carrier 80 to the other carriage. This feature allows the carrier 80 to travel to the extremity of one end of bars 60, 70. This facilitates cutting of loose tenon pockets and other recesses or holes up to and including an edge of a workpiece such as a door 300. Without this facility, the presence of a carriage can block travel of the drill bit to an edge of the workpiece. In some embodiments of the invention the position of at least one of the carriages 40, 50 may be adjusted. For example, thumbscrews may be provided to allow the carriages to be moved along the bars 60, 70.

FIG. 22 shows apparatus mounted to a door following cutting of lock plate recess 1100 and a mortice recess 1110 for a lock.

In a second embodiment of the invention (FIG. 9), the carrier 80 is provided with a cylindrical cut-out 81 for rotatably receiving an elastomeric bobbin 710 (FIG. 10). The bobbin 710 has a central hole 720 for rotatably receiving a shaft of a drill 200. The other components of the second embodiment are generally similar to those of the first embodiment, and the general description in connection with the first embodiment applies also to the second embodiment.

In a third embodiment of the invention (FIG. 11), lateral movement of the carrier 80 may be effected by means of clamps 810 provided with rotary handles 820. By adjusting the positions of the clamps 810 in relation to clamp brackets 830, the lateral position of the carrier 80 may be adjusted.

A drill bit 200 suitable for use with the apparatus 10 is shown in FIG. 12. The drill bit comprises a cutting element 400 at a leading end 405 of the drill bit 200, designed to produce small swarf when cutting. A cylindrical PTFE collar or bobbin 220 is fitted to the bit 200 behind the cutting element 400, the diameter of the collar corresponding to that of the cylindrical cut-out 81 such that the collar may be inserted into the cut-out 81.

Upon insertion into the cut-out 81, the collar 220 abuts a circumferential shoulder of the cut-out (not shown) proximate a rear face of the carrier 80, which faces the leading surface 310 of the door 300. The shoulder prevents the collar from sliding past the rear face of the carrier 80, but still permits the cutting element 400 to pass through the carrier 80 to cut the leading surface 310 of the door 300.

The collar 220 acts as a friction reducing element and a vibration damper. In use, the drill bit rotates within the collar 220, which provides both lateral and longitudinal stability to the drill bit, since substantially lateral forces are encountered as the cutting element 300 is moved along the edge of the door 300. The presence of the collar 220 enables an accurate cut to be made, with a high quality surface finish.

In order to cut a mortice pocket having a depth exceeding that of the cutting element 400, a series of cuts are made along the edge of the door, of increasing depth, until the desired pocket depth is achieved.

A depth stop 230 is mounted behind the collar 220, and allows the depth to which a cut is to be made to be set. The depth stop 230 comprises an annular ring 235, slidable along the bit 200, with a friction lock comprising a grub screw passing radially through the ring. Tightening of the grub screw against the bit 200 allows the depth stop 230 to be locked in position.

The present embodiment of the invention is designed for use with a standard electric hand drill 1000. In alternate embodiments, the apparatus comprises an integral electric motor and drill chuck, eliminating the need to provide a separate hand drill 1000.

The cutting element 400 according to the present embodiment (FIGS. 12 to 15) is provided with four radial blades 420, an outer longitudinal edge 450 of each blade 420 describing a substantially helical form coaxial with the drill bit 200. The longitudinal edge 450 is provided with a plurality of teeth 460 that facilitate cutting of the workpiece when the drill bit is translated in a radial direction.

The leading radial edge 430 of each blade 420 is provided with a cutting edge 430 to enable cutting of the workpiece as the drill bit is driven along an axial direction into the workpiece. Furthermore, the leading end 405 of the drill bit 200 is provided with an axial spike 410 projecting axially away from the drill bit 200. The spike assists the cutting element 400 when the cutting element 400 first penetrates into the door 300, by promoting rotational stability.

In an alternative embodiment of the invention (FIG. 16), a drill bit 200 is provided with a cutting element 500. The cutting element comprises four blades 520 disposed radially at the leading end 505 of the drill bit 200. A cutting edge 530 is disposed along a radial leading edge of each blade 520. The edge 530 is designed to cut when rotated in an anticlockwise direction when viewed with the leading end 505 towards the viewer. Each blade 520 has a leading surface 540 forming an angle generally in excess of 90° with a plane normal to the axis of rotation of the drill bit 200. This plane is generally also the plane of the leading surface 310 of a door 300 to be cut, and this angle enables the blade 520 to slice material from the leading surface 310 and to lift the cut material away from the surface 310 as the bit 200 rotates.

A portion 535 of the cutting edge 530 proximate the axis of rotation of the drill bit 200 is shaped so as to provide a slight protrusion axially away from the cutting element 500. This feature provides for smoother entry of the cutting element into the door 300 since the raised portion 535 will enter the leading surface 310 before the remainder of the cutting edge 530.

The outer longitudinal edges 550 of the blades 520 are also provided with cutting edges 570 that provide a cutting action when the cutting element is translated in a radial direction.

In an embodiment of the invention a clamp adaptor 700 (FIG. 17) is provided to enable the apparatus to be mounted in juxtaposition with a front side 320 or a back side 330 of the door. Clamp adaptor 700 comprises a G-clamp having a U-shaped body portion 710 and a screw portion 750. Body portion 710 is provided with hook portions 720 (FIGS. 17 and 18). The hook portions 720 are configured to abut clamping members 800 of the apparatus 10 when an end 715 of the body 10 of the clamp adaptor 700 is gripped between clamp members 800 of the apparatus 10. End 715 is an end of the body portion 710 opposite the end through which screw member 750 passes.

With clamp adaptor 700 gripped by clamp members 800 of the apparatus 10, clamp adaptor 700 may be clamped about the leading surface 310 of the door 300. In this configuration, clamp adaptor 700 grips opposite faces 320, 330 of the door 300. Apparatus 10 is thereby secured to the door 300 with carrier 80 in juxtaposition with one of the faces 310, 320 of the door 300.

Thus, with a drill bit 200 mounted to the carrier 80, a hole may be drilled through a thickness of the door from one face of the door to the opposite face. Furthermore, an oval shaped hole may be formed by moving the carrier 80 (and thereby a drill mounted to the carrier) with respect to the door 300. An oval-shaped hole may be required, for example, when installing an oval-shaped cylinder lock such as a Eurolock.

As shown in FIG. 19, hook portions 720 of clamp adaptor 700 assist in preventing apparatus 10 from being pulled away from clamp adaptor 700 in use.

In a further embodiment of the invention, a pair of adaptors 900 are provided for mounting a mortice cutter away from an edge of a door or other article in which a hole or recess is to be formed. The adaptors 900 each have a block portion 910 and a threaded spindle portion 920 attached to the block potion (FIG. 20). In the present embodiment the block portion is rotatably connected to the spindle portion, but in other embodiments the portions are not rotatable with respect to one another.

In use, a pair of holes are drilled through a face of the door (eg at locations where a letter or mail plate is to be mounted). The spindles are then passed through respective holes and secured to the door by means of nuts such as wing nuts. In some embodiments of the invention the spindle is not threaded, and other means of securing the spindles to the door are used.

The mortice cutter is then attached to the block portions 910 of the adaptors 900 by means of the clamping jaws 22 of the mortice cutter. The cutter is thereby securely mountable to a portion of a door without requiring to be mounted to an edge of a door. In the mounted position as described above, the cutter may be used to cut a letter hole in the door to allow letters to be posted through the door.

It will be appreciated that the adaptors could also be used to cut apertures or recesses in a door for any required purpose, such as recesses for name plates and other recessed fittings, apertures for windows, etc.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. An apparatus for use in cutting a mortice pocket in a leading edge of a door in-situ, the apparatus comprising:
at least one elongate guide means;
clamping means for clamping the elongate guide means to a door or other workpiece such that the elongate guide means is substantially parallel to a leading edge thereof;
a drill guide means mounted on the elongate guide means so as to be reciprocally moveable therealong; and
translating means to translate the drill guide means in a direction having a resolved component normal to the elongate guide means;
wherein the drill guide means comprises a bearing block and a saddle member, the saddle member having a bearing block aperture formed therethrough arranged to releasably receive the bearing block therein, the bearing block having a hole therethrough adapted snugly to receive a drill shaft such that the drill shaft is supported, directly or indirectly, by the bearings of the bearing block and is rotatable therein, and wherein at least one of the bearing block aperture and the bearing block is tapered.

2. Apparatus as claimed in claim 1 wherein both the bearing block aperture and the bearing block are tapered.

3. Apparatus as claimed in claim 2 wherein a taper angle of the bearing block is in the range from about 1° to about 10°.

4. Apparatus as claimed in claim 3 wherein the taper angle is in the range from about 3° to about 6°.

5. Apparatus as claimed in claim 1 wherein a relative angle is arranged between an outer surface of the bearing block receivable within the bearing block aperture, and an inner surface of the bearing block aperture, this angle being in the range from about 0.1° to about 5°.

6. Apparatus as claimed in claim 5 wherein the bearing block aperture has a greater taper angle than the bearing block.

7. Apparatus as claimed in claim 5 wherein the bearing block aperture has a lower taper angle than the bearing block.

8. Apparatus as claimed in claim 6 or claim 7 wherein the relative angle is in the range from about 0.1° to about 0.5°.

9. Apparatus as claimed in claim 8 wherein the relative angle is in the range from about 0.2° to about 0.3°.

10. Apparatus as claimed in claim 1 wherein the bearing block comprises a keyway along an outer face thereof, the keyway being arranged to cooperate with a complementary key formation of the saddle, thereby to secure the bearing block to the saddle.

11. Apparatus as claimed in claim 10 wherein the keyway comprises an axial portion.

12. Apparatus as claimed in claim 10 wherein the keyway comprises a helical portion.

13. An apparatus for use in cutting a mortice pocket in a leading edge of a door in-situ, the apparatus comprising:
at least one elongate guide means;
clamping means for clamping the elongate guide means to a door or other workpiece such that the elongate guide means is substantially parallel to a leading edge thereof; and
a drill guide means mounted on the elongate guide means so as to be reciprocally moveable therealong;
the apparatus further comprising means for translating the drill guide means in a direction having a resolved component normal to the elongate guide means;
wherein the drill guide means includes a cylindrical aperture configured rotatably to receive a bobbin, the bobbin having a through hole adapted to receive a drill shaft, and wherein the bobbin is made of or is coated with a low-friction material, or is provided with a collar made of a low-friction material.

14. An apparatus as claimed in claim 13, wherein there is further provided first and second adjustable stopping means on the elongate guide means so as to define limits of travel of the drill guide means.

15. An apparatus as claimed in claim 13, wherein a rack and pinion or worm screw mechanism is provided for moving the drill guide means along the elongate guide means.

16. An apparatus as claimed in claim 13, wherein a rack and pinion or worm screw mechanism is provided for translating the drill guide means in the direction having a resolved component normal to the elongate guide means.

17. An apparatus as claimed in claim 13, wherein there is provided at least first and second elongate guide means.

18. An apparatus as claimed in claim 17, wherein the first elongate guide means comprises a rack of said rack and pinion mechanism or a worm screw of said worm screw mechanism.

19. An apparatus as claimed in claim 18, wherein the stopping means are mounted on the second elongate guide means.

20. An apparatus as claimed in claim 13, wherein the means for translating the drill guide means in a lateral direction normal to the elongate guide means is provided by the clamping means.

21. An apparatus as claimed in claim 13, wherein the bobbin is made of an elastomeric material.

22. An apparatus as claimed in any preceding claim 13, further comprising a drill shaft received in the drill guide means, the drill shaft being provided with a drill bit.

23. An apparatus as claimed in claim 22, wherein the drill shaft is adapted for connection to a power drill.

24. An apparatus as claimed in claim 22, further comprising an integral motor for rotating the drill shaft.

25. An apparatus as claimed in claim 22, wherein the drill bit is adapted to produce small swarf.

26. An apparatus as claimed in claim 22 wherein the shaft has a major axis along a length of the shaft about which the drill bit is rotated in normal operation, wherein a leading end of the shaft is provided with a plurality of blades disposed radially with respect to the major axis of the shaft, the blades having a leading edge, a leading surface and a longitudinal edge, wherein the leading edge is shaped to provide a cutting edge, the leading surface is disposed on the side of the blade that faces a direction of rotation of the drill bit, and the longitudinal edge is distal the major axis.

27. An apparatus as claimed in claim 26, wherein the leading end of the shaft is provided with a spike, the spike lying along the major axis and protruding away from the drill bit, the longitudinal edge describing a substantially helical faun, coaxial with said major axis.

28. An apparatus as claimed in claim 27, wherein the blades are provided with a plurality of teeth along said longitudinal edge.

29. An apparatus as claimed in claim 26, wherein the leading surface is generally planar, and the blades are disposed such that an angle between the plane of the surface of the workpiece to be cut and the plane of the leading surface is greater than substantially 90°.

30. An apparatus as claimed in claim 29, wherein the longitudinal edge is substantially parallel to the major axis and is provided with a cutting edge.

31. An apparatus as claimed in claim 26, wherein the drill bit is provided with four blades.

32. An apparatus as claimed in claim 13 wherein the clamping means comprises at least one clamp, the at least one clamp being operable to grip opposite faces of a door.

33. An apparatus as claimed in claim 32 wherein the clamping means is further operable to grip a clamp adaptor, the clamp adaptor comprising means for attachment to the leading edge of a door.

34. An apparatus as claimed in claim 33 wherein the clamp adaptor is configured to grip opposite faces of a door, wherein, with the apparatus clamped to the clamp adaptor, the apparatus is mountable with the drill guide means in juxtaposition with a face of the door.

35. An apparatus as claimed in claim 34 wherein the clamp adaptor is provided with at least one hook means, the at least one hook means being configured to hook around a portion of the apparatus thereby to restrain movement of the guide means relative to the adaptor.

36. Apparatus as claimed in claim 13 further comprising a clamp adaptor comprising a clamp block, the clamp block having a spindle connected thereto.

37. Apparatus as claimed in claim 36 wherein the spindle comprises a threaded rod.

38. Apparatus as claimed in claim 13 wherein the drill guide means comprises index means arranged to cooperate with the elongate guide means to index a position of the drill guide means with respect thereto.

39. Apparatus as claimed in claim 13 wherein the clamping means comprises a pair of opposed jaws.

40. Apparatus as claimed in claim 39 wherein the clamping means is arranged to open or close the jaws in a symmetrical manner thereby to allow a portion of the clamping means to remain substantially midway between the jaws.

41. Apparatus as claimed in claim 40 wherein the apparatus comprises a detent mechanism arranged to allow the drill guide means to be located at a position midway between the jaws.

42. A method of forming a mortice pocket comprising the steps of:
providing a mortice cutting apparatus according to claim 1; and
cutting a hole in a workpiece using the apparatus.

43. A method as claimed in claim 42 comprising the steps of:
cutting a hole to a first depth; and
moving the drill guide means along the elongate guide means thereby to cut an elongate slot in the workpiece.

44. A method of forming a letter box aperture in the face of a door, comprising the steps of:
providing a mortice cutting apparatus according to claim 1;
drilling holes through the door to provide fixing apertures for a letter box plate;
clamping the apparatus to a face of a door by inserting clamp blocks through the fixing apertures and fixing them to the face of the door whereby the apparatus may itself be clamped to the door; and
cutting a letter box aperture in the face of the door using the apparatus.

45. (canceled)
